(19) United States
(12) Patent Application Publication
(10) Pub. No.: US 2026/0328150 A1
(43) Pub. Date: Oct. 22, 2026

(54) IN-CYLINDER PRESSURE ESTIMATION DEVICE FOR INTERNAL COMBUSTION ENGINE

(71) Applicant: TOYOTA JIDOSHA KABUSHIKI KAISHA, Toyota-shi (JP)

(72) Inventor: Masanori Toya, Inazawa-shi (JP)

(73) Assignee: TOYOTA JIDOSHA KABUSHIKI KAISHA, Toyota-shi (JP)

(21) Appl. No.: 19/530,788

(22) Filed: Feb. 5, 2026

(30) Foreign Application Priority Data
Apr. 18, 2025 (JP) 2025-068710

(51) Int. Cl. F02D 35/02

(52) U.S. Cl. CPC F02D 35/024

(57) ABSTRACT

A control device functioning as an in-cylinder pressure estimation device for an engine executes a pre-ignition determination process for determining whether pre-ignition has occurred in the cylinder. The control device executes an in-cylinder pressure estimation process for estimating the maximum in-cylinder pressure when pre-ignition is determined to have occurred in the cylinder in the pre-ignition determination process. In the in-cylinder pressure estimation process, the control device estimates the maximum in-cylinder pressure based on the engine speed, the engine load factor, and the angular velocity variation ratio. The angular velocity variation ratio is a quotient obtained by dividing the amount of decrease in the crank angular velocity in the second interval, which is a portion of the first interval, which is an interval that spans the compression stroke and the combustion stroke immediately following the compression stroke, by the amount of decrease in the crank angular velocity in the first interval.

### CROSS-REFERENCE TO RELATED APPLICATION

This application claims priority to Japanese Patent Application No. 2025-068710 filed on Apr. 18, 2025. The disclosure of the above-identified application, including the specification, drawings, and claims, is incorporated by reference herein in its entirety.

### BACKGROUND

### 1. Technical Field

The present disclosure relates to in-cylinder pressure estimation devices for internal combustion engines.

### 2. Description of Related Art

Japanese Unexamined Patent Application Publication No. 2013-160200 (JP 2013-160200 A) discloses an abnormal combustion detection device for an internal combustion engine that determines whether knocking or pre-ignition has occurred based on output from a vibration sensor that detects vibration of a cylinder block. In this abnormal combustion detection device, the type of abnormal combustion is identified based on the peak value of the amplitude of an abnormal combustion signal output from the vibration sensor and the peak angle, that is, the crank angle (CA) at which that peak occurs.

When the peak value is greater than a pre-ignition determination threshold, the abnormal combustion detection device determines that pre-ignition, rather than knocking, has occurred. In a region where the knocking detection interval and the pre-ignition detection interval overlap, the pre-ignition determination threshold is set to a value greater than the maximum peak value expected when knocking occurs.

### SUMMARY

The maximum in-cylinder pressure generated during pre-ignition tends to be higher as the engine speed becomes higher. The maximum in-cylinder pressure generated during pre-ignition also tends to be higher as the engine load factor becomes higher. It is therefore possible to estimate the maximum in-cylinder pressure generated during pre-ignition, based on the engine speed and the engine load factor. However, there is room for improvement in the estimation of the maximum in-cylinder pressure during pre-ignition.

According to one aspect of the present disclosure, an in-cylinder pressure estimation device for an internal combustion engine including a cylinder includes a processing circuit. The processing circuit is configured to determine whether pre-ignition has occurred in the cylinder and estimate a maximum in-cylinder pressure of the cylinder when the pre-ignition is determined to have occurred in the cylinder. The processing circuit is configured to estimate the maximum in-cylinder pressure based on an engine speed, an engine load factor, and an angular velocity variation ratio. The angular velocity variation ratio is a quotient obtained by dividing an amount of decrease in a crank angular velocity in a second interval by an amount of decrease in the crank angular velocity in a first interval. The first interval is an interval that spans a compression stroke and a combustion stroke immediately following the compression stroke, and the second interval is a portion of the first interval.

With the above configuration, the processing circuit estimates the maximum in-cylinder pressure based on the angular velocity variation ratio in addition to the engine speed and the engine load factor. Accordingly, it is possible to improve the estimation accuracy of the maximum in-cylinder pressure as compared with a configuration in which the maximum in-cylinder pressure is estimated based only on the engine speed and the engine load factor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a control device functioning as an in-cylinder pressure estimation device for an internal combustion engine according to a first embodiment;

FIG. 2 is a flowchart showing a process executed by the control device of FIG. 1;

FIG. 3 shows graphs showing a change in crank angular velocity, where (a) of FIG. 3 shows a graph showing a change in crank angular velocity when pre-ignition occurs at a crank angle of B110, and (b) of FIG. 3 shows a graph showing a change in crank angular velocity when pre-ignition occurs at a crank angle of B70;

FIG. 4 is a graph illustrating an example of a relationship between an angular velocity variation ratio and a maximum in-cylinder pressure;

FIG. 5 shows graphs illustrating the in-cylinder pressure estimation device for an internal combustion engine according to a second embodiment, and (a) of FIG. 5 is a graph which shows change of crank angular velocity when a crank angle is B110 and pre-ignition occurs, and (b) of FIG. 5 is a graph which shows change of crank angular velocity when a crank angle is B70 and pre-ignition occurs; and

FIG. 6 is a graph illustrating an example of the relationship between the angular velocity variation ratio and the maximum in-cylinder pressure according to the second embodiment.

### DETAILED DESCRIPTION OF EMBODIMENTS

### First Embodiment

Hereinafter, an in-cylinder pressure estimation device for an internal combustion engine according to a first embodiment will be described with reference to the drawings.

### Configuration of Engine 10

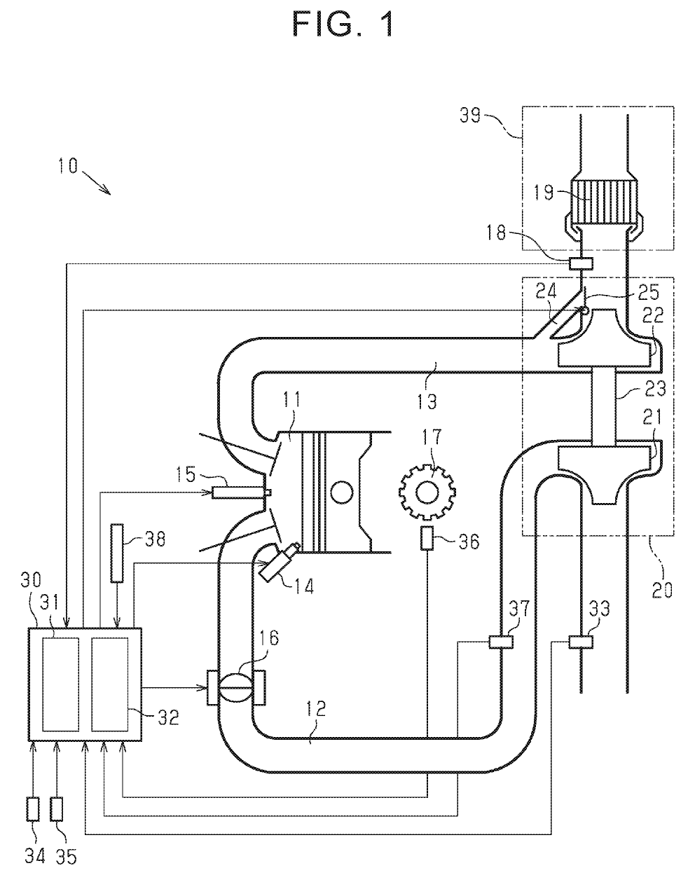

First, the configuration of the engine 10 will be described with reference to FIG. 1. In the present embodiment, the engine 10 is an internal combustion engine using hydrogen as a fuel. The engine 10 may be an internal combustion engine using gasoline as a fuel. The engine 10 includes a plurality of cylinders 11. None of the plurality of cylinders 11 is provided with an in-cylinder pressure sensor. FIG. 1 shows only one of the plurality of cylinders 11. In each of the plurality of cylinders 11, combustion of the air-fuel mixture is performed. Further, the engine 10 includes an intake passage 12, which is a passage for introducing intake air into the cylinder 11, and an exhaust passage 13, which is a passage for discharging exhaust air from the cylinder 11. The engine 10 further includes an in-cylinder injector 14 that injects fuel into the cylinder 11 to form an air-fuel mixture. The in-cylinder injector 14 is configured such that the fuel passage is opened by the valve body lifting inward. That is, the in-cylinder injector 14 is an in-cylinder valve-open type injector. Further, the engine 10 includes an ignition device 15 that ignites the air-fuel mixture in the cylinder 11 by spark discharge. A throttle valve 16 is installed in a portion of the intake passage 12 downstream of the compressor wheel 21. By changing the opening degree of the throttle valve 16, it is possible to adjust the amount of intake air introduced into the cylinder 11. The engine 10 generates the driving force of the vehicle by rotating the crankshaft 17 by the combustion of the air-fuel mixture in the cylinder 11.

The engine 10 includes a turbocharger 20. The turbocharger 20 includes a compressor wheel 21 installed in the intake passage 12 and a turbine wheel 22 installed in the exhaust passage 13. The compressor wheel 21 and the turbine wheel 22 are connected to each other via a turbine shaft 23. The exhaust passage 13 is provided with a bypass passage 24 which is a passage for flowing the exhaust gas downstream by bypassing the turbine wheel 22. A catalyst device 39 having a catalyst carrier 19 on which a catalyst for exhaust gas control is supported is provided at a portion downstream of the merging position of the bypass passage 24 and the exhaust passage 13. The exhaust passage 13 is provided with a wastegate valve 25 for opening and closing the outlet of the bypass passage 24. An exhaust gas temperature sensor 18 for detecting an exhaust gas temperature is provided in the exhaust passage 13.

### Configuration of Control Device 30

The engine 10 is controlled by a control device 30. The control device 30 also functions as an in-cylinder pressure estimation device. The control device 30 includes a control unit 31 and a Read Only Memory (ROM) 32. The control unit 31 includes a Central Processing Unit (CPU) and Random Access Memory (RAM). ROM32 stores programs and data for controlling the engine 10. The control unit 31 controls the engine 10 by reading and executing the program from ROM 32.

The control device 30 receives detection results of various sensors for detecting the operation state of the engine 10. The various sensors include an air flow meter 33, a vehicle speed sensor 34, an accelerator position sensor 35, a crank angle sensor 36, a supercharging pressure sensor 37, a vibration sensor 38, and an exhaust gas temperature sensor 18.

The air flow meter 33 is a sensor that detects an intake air amount that is a flow rate of the intake air flowing through the intake passage 12. In the present embodiment, the air flow meter 33 is positioned upstream of the compressor wheel 21 in the intake passage 12. The vehicle speed sensor 34 is a sensor that detects the speed of the vehicle. The control device 30 can calculate the engine load factor based on the detected value from the air flow meter 33. The engine load factor represents a ratio of the current cylinder inflow air amount to the cylinder inflow air amount when the engine 10 is steadily operated in a state where the throttle valve 16 is fully opened at the current engine speed. The cylinder inflow air amount is an amount of air flowing into each of the plurality of cylinders 11 in the intake stroke.

The accelerator position sensor 35 is a sensor that detects a depression amount of the accelerator pedal. The crank angle sensor 36 is a sensor that detects a crank angle that is a rotation angle of the crankshaft 17. The supercharging pressure sensor 37 is a sensor that detects a supercharging pressure that is a pressure of intake air in a portion of the intake passage 12 downstream of the compressor wheel 21 and upstream of the throttle valve 16. The vibration sensor 38 is used to detect vibration of the engine 10. The control unit 31 of the control device 30 can determine whether or not pre-ignition has occurred based on the vibration detected by the vibration sensor 38. The control unit 31 controls the fuel injection amount and the fuel injection timing of the in-cylinder injector 14, the ignition timing of the ignition device 15, the throttle opening degree, and the like based on the detection results of these sensors.

### Processing Executed by the Control Device 30

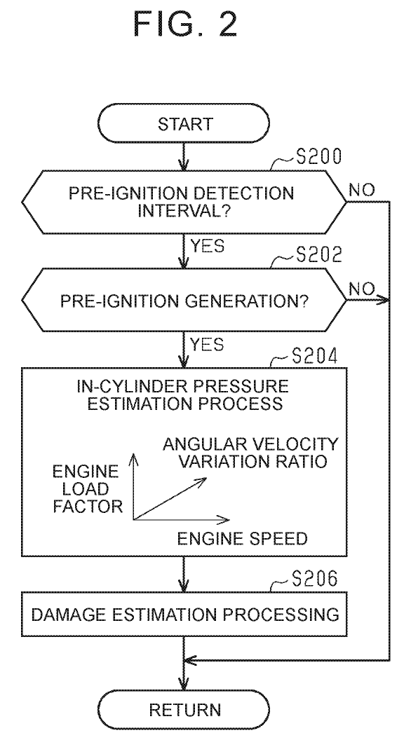

Processing executed by the control device 30 will be described below with reference to FIGS. 2 to 4. The control device 30 starts the process of FIG. 2 when the engine 10 is started. The control device 30 repeatedly executes the processing of FIG. 2 while the engine 10 is in operation.

In S200, the control device 30 determines whether or not the crank angle belongs to the pre-ignition detecting section for each of the plurality of cylinders 11. For one cylinder 11, the pre-ignition detecting section is, for example, in the range from 150° before top dead center (BTDC) to top dead center (TDC). Here, the top dead center means a crank angle at which the piston reaches the highest position in the cylinder 11 and serves as a boundary between the compression stroke and the combustion stroke. When a negative determination is made in S200 (S200: NO), the control device 30 ends the process of FIG. 2. When an affirmative determination is made in S200 (S200: YES), the control device 30 proceeds to S202.

In S202, the control device 30 executes a pre-ignition determination process for determining whether or not pre-ignition has occurred in the cylinder 11. As described above, the control device 30 can determine whether or not pre-ignition has occurred based on the vibration detected by the vibration sensor 38. For example, the control device 30 may determine that pre-ignition has occurred based on the amplitude of the vibration detected from the vibration sensor 38 being larger than a threshold value. Alternatively, the control device 30 may determine whether or not pre-ignition has occurred based on the variation in the crank angular velocity.

After S202, the control device 30 proceeds to S204. In S204, the control device 30 executes an in-cylinder pressure estimation process for estimating the maximum in-cylinder pressure in the cylinder 11. According to S202 and S204, the control device 30 executes the in-cylinder pressure estimation process when it is determined that the pre-ignition has occurred in the cylinder 11 in the pre-ignition determination process.

In the in-cylinder pressure estimation process, the control device 30 estimates the maximum in-cylinder pressure based on the engine speed, the engine load factor, and the angular velocity variation ratio. In the present embodiment, the control device 30 estimates the maximum in-cylinder pressure using a three-dimensional map in which a combination of the engine speed, the engine load factor, and the angular velocity variation ratio is associated with the maximum in-cylinder pressure. The estimated maximum in-cylinder pressure tends to increase as the engine speed increases, and increases as the engine load factor increases, and increases as the angular velocity variation ratio increases.

The engine load factor represents a ratio of the current cylinder inflow air amount to the cylinder inflow air amount when the engine 10 is steadily operated in a state where the throttle valve 16 is fully opened at the current engine speed. The angular velocity variation ratio is a quotient obtained by dividing the amount of decrease in the crank angular velocity in the second interval, which is a portion of the first interval, which is an interval that spans the compression stroke and the combustion stroke immediately following the compression stroke, by the amount of decrease in the crank angular velocity in the first interval. In the first embodiment, the second interval is an interval included in the compression stroke.

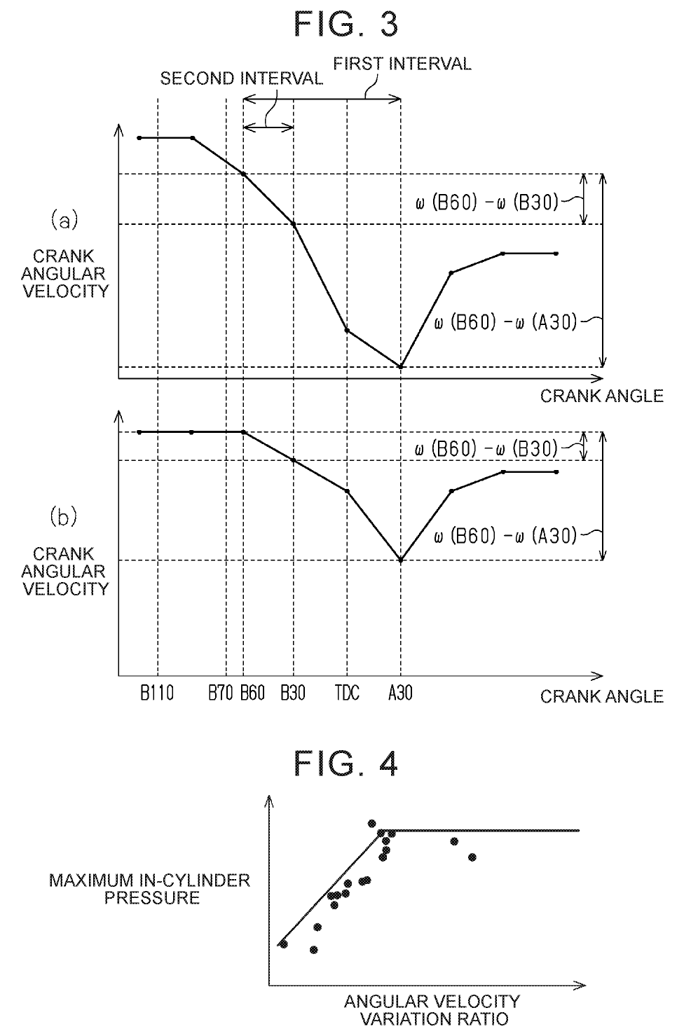

As illustrated in FIG. 3, the first interval is a section from B60 to A30. The first interval is a section that straddles the compression stroke (180° BTDC to TDC) and the combustion stroke (TDC to 180° ATDC) immediately after the compression stroke. The second interval is a section from B60 to B30. In FIG. 3, the X° BTDC (0 < X < 720) is described as BX. Further, in FIG. 3, the X° ATDC (0 < X < 720) is described as AX. ATDC is an abbreviation for after top dead center. The crank angular velocity when the crank angle is X° is expressed as ω(X). The angular velocity variation ratio is {ω(B60) – ω(B30)}/{ω(B60) – ω(A30)}.

FIG. 4 is a graph illustrating an example of a relationship between an angular velocity variation ratio and a maximum in-cylinder pressure in a case where the engine speed and the engine load factor are constant. As shown in FIG. 4, the estimated maximum in-cylinder pressure is higher as the angular velocity variation ratio is higher.

After S204, the control device 30 proceeds to S206. The control device 30 performs a damage estimation process in S206. The damage estimation process is performed based on the maximum in-cylinder pressure estimated in S204. The damage estimation process is, for example, a process of estimating the magnitude of damage caused by the combustion gas flowing into the in-cylinder injector 14. For example, in the damage estimation process, when the estimated maximum in-cylinder pressure is larger than the threshold value, the control device 30 executes fuel cut. Alternatively, the control device 30 may reduce the amount of fuel injected into the cylinder 11 as the estimated maximum in-cylinder pressure increases. After finishing S206, the control device 30 finishes the process of FIG. 2.

### Processing Executed by the Control Device 30

A graph showing a change in crank angular velocity when pre-ignition occurs at a B110 crank angle is shown in (a) of FIG. 3. A graph showing a change in crank angular velocity when pre-ignition occurs at a B70 crank angle is shown in (b) of FIG. 3. For these, the engine speed and the engine load factor are constant. The earlier the occurrence timing of pre-ignition, the faster the decrease in crank angular velocity is likely to occur.

As described above, the angular velocity variation ratio is a quotient obtained by dividing the amount of decrease in the crank angular velocity in the second interval by the amount of decrease in the crank angular velocity in the first interval. Specifically, the angular velocity variation ratio is {ω(B60) – ω(B30)}/{ω(B60) – ω(A30)}.

In the example shown in FIG. 3, the angular velocity variation ratio when pre-ignition occurs in B110 is higher than the angular velocity variation ratio when pre-ignition occurs in B70. As shown in FIG. 4, the estimated maximum in-cylinder pressure is higher as the angular velocity variation ratio is higher. Therefore, the maximum in-cylinder pressure estimated for (a) of FIG. 3 is higher than the maximum in-cylinder pressure estimated for (b) of FIG. 3.

### Effects of First Embodiment

(1-1) The control device 30 functioning as an in-cylinder pressure estimation device of the engine 10 having the cylinder 11 executes a pre-ignition determination process of determining whether or not pre-ignition has occurred in the cylinder 11 (S202). The control device 30 executes an in-cylinder pressure estimation process of estimating the maximum in-cylinder pressure in the cylinder 11 when it is determined that the pre-ignition has occurred in the cylinder 11 in the pre-ignition determination process (S204). In the in-cylinder pressure estimation process, the control device 30 estimates the maximum in-cylinder pressure based on the engine speed, the engine load factor, and the angular velocity variation ratio. The angular velocity variation ratio is a quotient obtained by dividing the amount of decrease in the crank angular velocity in the second interval, which is a portion of the first interval, which is an interval that spans the compression stroke and the combustion stroke immediately following the compression stroke, by the amount of decrease in the crank angular velocity in the first interval.

The maximum in-cylinder pressure tends to increase as the timing of pre-ignition occurs earlier. The reason for this tendency will be described below. The earlier the timing of pre-ignition generation, the longer the period during which combustion occurs in a period before the original ignition timing. This means that the maximum in-cylinder pressure increases because the energy generated by the combustion caused by the pre- ignition increases. Therefore, the maximum in-cylinder pressure tends to increase as the timing of pre-ignition generation increases.

The earlier the timing of pre-ignition occurrence, the lower the crank angular velocity tends to be at the earlier timing in the first interval. The angular velocity variation ratio correlates with the timing at which the crank angular velocity decreases in the first interval. Therefore, the maximum in-cylinder pressure is correlated with the angular velocity variation ratio.

According to the above configuration, the control device 30 estimates the maximum in-cylinder pressure based on the angular velocity variation ratio in addition to the engine speed and the engine load factor. Therefore, it is possible to improve the estimation accuracy of the maximum in-cylinder pressure as compared with a configuration in which the maximum in-cylinder pressure is estimated based only on the engine speed and the engine load factor.

(1-2) The second interval is a section included in the compression stroke, and the estimated maximum in-cylinder pressure is higher as the angular velocity variation ratio is higher.
The earlier the timing of the pre-ignition generation, the earlier the timing at which the crank angular velocity decreases due to the pre-ignition. The earlier the crank angular velocity decreases, the higher the angular velocity variation ratio in the case where the second interval is a section included in the compression stroke.

Therefore, the maximum in-cylinder pressure increases as the angular velocity variation ratio increases. According to the above configuration, the tendency can be reflected in the estimation of the maximum in-cylinder pressure.
(1-3) The control device 30 is configured to estimate the maximum in-cylinder pressure using a three-dimensional map in which a combination of the engine speed, the engine load factor, and the angular velocity variation ratio is associated with the maximum in-cylinder pressure.

Processing for estimating the maximum in-cylinder pressure is simple compared with a configuration in which the maximum in-cylinder pressure is estimated by correcting the provisional maximum in-cylinder pressure calculated based on the engine speed and the engine load factor based on the angular velocity variation ratio.

(1-4) In the first embodiment, the angular velocity variation ratio is {ω(B60) – ω(B30)}/{ω(B60) – ω(A30)}. This means that it is easier to capture pre-ignition that is generated earlier than in the second embodiment described later in which the angular velocity variation ratio is {ω(TDC) – ω(A30)}/{ω(B60) – ω(A30)}. Therefore, in the first embodiment, the estimation accuracy of the maximum in-cylinder pressure according to the pre-ignition in which the generation timing is early is high.

### Second Embodiment

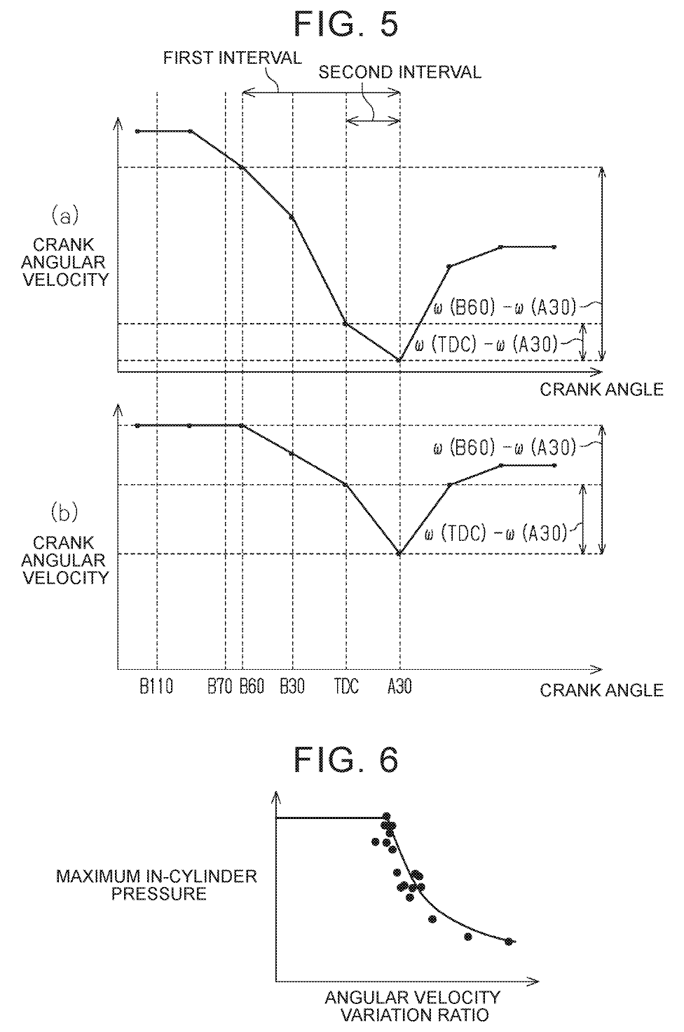

A in-cylinder pressure estimation device for an internal combustion engine according to a second embodiment will be described with particular reference to FIGS. 5 and 6. Hereinafter, descriptions of configurations common to the second embodiment and the first embodiment will be omitted as appropriate. In the first embodiment, the second interval is a section included in the compression stroke, whereas in the second embodiment, the second interval is a section included in the combustion stroke. Accordingly, the maximum in-cylinder pressure estimated in the first embodiment is higher as the angular velocity variation ratio is higher, whereas the maximum in-cylinder pressure estimated in the second embodiment is higher as the angular velocity variation ratio is lower.

As shown in FIG. 5, the first interval is a section from B60 to A30. The second interval is a section from TDC to A30. As described above, the angular velocity variation ratio is a quotient obtained by dividing the amount of decrease in the crank angular velocity in the second interval by the amount of decrease in the crank angular velocity in the first interval. Specifically, the angular velocity variation ratio is {ω(TDC) – ω(A30)}/{ω(B60) – ω(A30)}.

As shown in FIG. 6, the estimated maximum in-cylinder pressure is higher as the angular velocity variation ratio is lower.

### Functions of Second Embodiment

A graph showing a change in crank angular velocity when pre-ignition occurs at a crank angle of B110 is shown in (a) of FIG. 5. A graph showing a change in crank angular velocity when pre-ignition occurs at a B70 crank angle is shown in (b) of FIG. 5. For these, the engine speed and the engine load factor are constant. The earlier the occurrence timing of pre-ignition, the faster the decrease in crank angular velocity is likely to occur.

As described above, the angular velocity variation ratio is a quotient obtained by dividing the amount of decrease in the crank angular velocity in the second interval by the amount of decrease in the crank angular velocity in the first interval. Specifically, the angular velocity variation ratio is {ω(TDC) – ω(A30)}/{ω(B60) – ω(A30)}.

In the example shown in FIG. 5, the angular velocity variation ratio when pre-ignition occurs in B110 is lower than the angular velocity variation ratio when pre-ignition occurs in B70. As shown in FIG. 6, the estimated maximum in-cylinder pressure is higher as the angular velocity variation ratio is lower. Therefore, the maximum in-cylinder pressure estimated for (a) of FIG. 5 is higher than the maximum in-cylinder pressure estimated for (b) of FIG. 5.

### Effects of Second Embodiment

(2-1) The second interval is an interval included in the combustion stroke, and the estimated maximum in-cylinder pressure is higher as the angular velocity variation ratio is lower.

The earlier the timing of the pre-ignition generation, the earlier the timing at which the crank angular velocity decreases due to the pre-ignition. The earlier the crank angular velocity decreases, the lower the angular velocity variation ratio in the case where the second interval is an interval included in the combustion stroke.

Therefore, the maximum in-cylinder pressure increases as the angular velocity variation ratio decreases. According to the above configuration, the tendency can be reflected in the estimation of the maximum in-cylinder pressure.
(2-2) In the second embodiment, the angular velocity variation ratio is {ω(TDC) – ω(A30)}/{ω(B60) – ω(A30)}. This means that it is easier to capture a pre-ignition that is slower in generation timing than the first embodiment in which the angular velocity variation ratio is {ω(B60) – ω(B30)}/{ω(B60) – ω(A30)}. Therefore, in the second embodiment, the estimation accuracy of the maximum in-cylinder pressure according to the pre-ignition in which the generation timing is slow is high.

### Modifications

The elements that can be modified in the first embodiment and the second embodiment are as follows. The following modifications may be implemented in combination with each other to the extent that they are not technically inconsistent.

S200 and/or S206 may be omitted for the first embodiment and the second embodiment.

In the first embodiment and the second embodiment, the specific ranges of the first interval and the second interval can be appropriately changed.

In the first embodiment and the second embodiment, the control device 30 estimates the maximum in-cylinder pressure using a three-dimensional map in which a combination of the engine speed, the engine load factor, and the angular velocity variation ratio is associated with the maximum in-cylinder pressure. However, this is only an example. For example, the control device 30 may estimate the maximum in-cylinder pressure by correcting the provisional maximum in-cylinder pressure calculated based on the engine speed and the engine load factor based on the angular velocity variation ratio.

In the first embodiment and the second embodiment, the control device 30 includes a control unit 31 and a Read Only Memory (ROM) 32. The control unit 31 includes Central Processing Unit (CPU) and Random Access Memory (RAM). The control device 30 executes software processing. However, this is merely an example. For example, the control device 30 may include a dedicated hardware circuit that processes at least a part of the software processing executed in the above-described embodiment. Dedicated hardware circuitry is, for example, Application Specific Integrated Circuit (ASIC). That is, the control device 30 may have any of the following configurations (a) to (c). (a) The control device 30 includes a processing device that executes all processes in accordance with a program, and a program storage device such as a ROM that stores a program. That is, the control device 30 includes a software execution device. (b) The control device 30 includes a processing device that executes a part of processing according to a program, and a program storage device. Furthermore, the control device 30 includes dedicated hardware circuits for executing the remaining processing. (c) The control device 30 includes a dedicated hardware circuit for executing all processes. Here, a plurality of software execution devices and/or dedicated hardware circuits may be provided. That is, the process may be performed by a processing circuitry including at least one of a software executing device and dedicated hardware circuitry. The processing circuit may include a plurality of software execution devices and dedicated hardware circuits. A program storage device or computer readable medium includes a storage device that is any available medium that can be accessed by a general purpose or special purpose computer.

What is claimed is:

1. An in-cylinder pressure estimation device for an internal combustion engine including a cylinder, the in-cylinder pressure estimation device comprising a processing circuit, wherein:
the processing circuit is configured to
determine whether pre-ignition has occurred in the cylinder, and
estimate a maximum in-cylinder pressure of the cylinder when the pre-ignition is determined to have occurred in the cylinder; and
the processing circuit is configured to estimate the maximum in-cylinder pressure based on an engine speed, an engine load factor, and an angular velocity variation ratio, the angular velocity variation ratio being a quotient obtained by dividing an amount of decrease in a crank angular velocity in a second interval by an amount of decrease in the crank angular velocity in a first interval, the first interval being an interval that spans a compression stroke and a combustion stroke immediately following the compression stroke, and the second interval being a portion of the first interval.

2. The in-cylinder pressure estimation device according to claim 1, wherein the second interval is an interval included in the compression stroke, and the maximum in-cylinder pressure is higher as the angular velocity variation ratio becomes higher.

3. The in-cylinder pressure estimation device according to claim 1, wherein the second interval is an interval included in the combustion stroke, and the maximum in-cylinder pressure is higher as the angular velocity variation ratio becomes lower.

4. The in-cylinder pressure estimation device according to claim 1, wherein the processing circuit is configured to estimate the maximum in-cylinder pressure using a three-dimensional map in which combinations of the engine speed, the engine load factor, and the angular velocity variation ratio are associated with the maximum in-cylinder pressure.
